(19) United States
(12) Patent Application Publication
(10) Pub. No.: US 2016/0202540 A1
(43) Pub. Date: Jul. 14, 2016

(54) DISPLAY DEVICE AND MANUFACTURING METHOD THEREOF

(71) Applicant: Samsung Display Co., Ltd., Yongin-City (KR)

(72) Inventors: Hee Keun LEE, Suwon-si (KR); Dong Woo KIM, Seoul (KR); Dong Youb OH, Seoul (KR)

(21) Appl. No.: 14/737,270

(22) Filed: Jun. 11, 2015

(30) Foreign Application Priority Data
Jan. 8, 2015 (KR) 10-2015-0002965

(51) Int. Cl. G02F 1/1333; G02F 1/1341; G02F 1/1337; G02F 1/1368; G02F 1/1343

(52) U.S. Cl. CPC G02F 1/133377; G02F 1/1368; G02F 1/134309; G02F 1/1337; G02F 1/1341

(57) ABSTRACT

A display device that can simplify the manufacturing process thereof is provided. The display device includes: a substrate; a thin film transistor disposed on the substrate; a pixel electrode connected to the thin film transistor; a roof layer formed above the pixel electrode in such a manner so as to be spaced apart from the pixel electrode with a microcavity interposed therebetween; a liquid crystal layer disposed in the microcavity; and an encapsulation layer disposed on the roof layer and sealing the microcavity, wherein the roof layer has an L-shape.

### CROSS-REFERENCE TO RELATED APPLICATION

This application claims priority to and the benefit of Korean Patent Application No. 10-2015-0002965 filed in the Korean Intellectual Property Office on Jan. 8, 2015, the entire contents of which are incorporated herein by reference.

### BACKGROUND

(a) Technical Field

The present disclosure relates to a display device and a manufacturing method thereof, and more particularly, to a display device that simplifies the manufacturing process.

(b) Description of the Related Art

Liquid crystal displays are one of the most widely used flat panel displays today. Typically, a liquid crystal display includes two display panels on which electric field generating electrodes, such as a pixel electrode and a common electrode, are formed, and a liquid crystal layer formed therebetween. The liquid crystal display displays an image by controlling the polarization of incident light transmitted through the liquid crystal layer. To control the polarization of incident light, the liquid crystal display generates an electric field in the liquid crystal layer by applying a voltage to the electric field generating electrodes to determine the alignment of the liquid crystal molecules in the liquid crystal layer.

The two display panels constituting the liquid crystal display may include a thin film transistor display panel and an opposing display panel. A gate line to transmit a gate signal and a data line to transmit a data signal may be alternately formed on the thin film transistor display panel to intersect each other. A thin film transistor connected to the gate line and the data line, a pixel electrode connected to the thin film transistor, etc., may also be formed on the thin film transistor display panel. A light blocking member, color filters, a common electrode, etc., may be formed on the opposing display panel. In some cases, the light blocking member, the color filters, and the common electrode may instead be formed on the thin film transistor display panel.

However, conventional liquid crystal displays are heavy, thick, and expensive, and require a long processing time because two substrates are used and individual components are formed on the two substrates.

The above information disclosed in this Background section is only for enhancement of understanding of the background of the system and method and therefore may contain information that does not form the prior art that is already known in this country to a person of ordinary skill in the art.

### SUMMARY

The present system and method provide a display device and a manufacturing method thereof in which the width, thickness, cost, and manufacturing processing time of the display device is reduced by manufacturing the display device using one substrate to simplify the manufacturing process.

An exemplary embodiment of the present system and method provides a display device including: a substrate; a thin film transistor disposed on the substrate; a pixel electrode connected to the thin film transistor; a roof layer formed above the pixel electrode to be spaced apart from the pixel electrode with a microcavity therebetween; a liquid crystal layer disposed in the microcavity; and an encapsulation layer disposed on the roof layer and sealing the microcavity, wherein the roof layer has an L-shape.

The display device may include a plurality of microcavities and a plurality of roof layers.

The number of roof layers may be equal to the number of microcavities.

Each roof layer may include: a column portion covering one side surface of the microcavity; a ceiling portion covering the top surface of the microcavity; and a connecting portion connecting the column portion and the ceiling portion.

The plurality of roof layers may include a first roof layer and a second roof layer that are adjacent to each other, one side surface and the top surface of the microcavity may be covered with the first roof layer, and the other side surface of the microcavity may be covered with the second roof layer.

The display device may further include a common electrode disposed between the first roof layer and the second roof layer.

The first roof layer and the second roof layer may be only separated from each other by the common electrode interposed therebetween.

The common electrode may be disposed on the top surface, bottom surface, and side surface of the ceiling portion of a roof layer and on the top surface and side surface of the connecting portion of the roof layer.

The common electrode may include a first common electrode disposed on the first roof layer and a second common electrode disposed on the second roof layer, and the first common electrode and the second common electrode may be connected to each other.

The width of the connecting portion may be smaller than the width of the column portion.

Another exemplary embodiment of the present system and method provides a manufacturing method of a display device, the method including: forming a plurality of pixel electrodes on a substrate; forming an organic layer between the pixel electrodes; forming an alignment layer on the pixel electrodes and the organic layer; bending the organic layer to form a roof layer, with a microcavity interposed between the roof layer and the pixel electrode; forming a liquid crystal layer by injecting a liquid crystal material into the microcavity; and sealing the microcavity by forming an encapsulation layer to cover exposed parts of the microcavity.

The method may further include forming at least one groove on the side of the organic layer.

The groove may have a V-shape.

The alignment layer may be disposed within the groove.

In the bending of the organic layer, the organic layer may be bent by performing a heat treatment process at a temperature between 200 and 250 degrees Celsius.

In the forming of the organic layer, the organic layer may be further formed on the pixel electrode, wherein the organic layer may have a first thickness at a portion overlapping the pixel electrode and a second thickness at a portion not overlapping the pixel electrode, and the second thickness is greater than the first thickness.

The method may further include forming a common electrode only on the portion of the organic layer having the second thickness after forming the organic layer.

The method may further include removing the portion of the organic layer having the first thickness.

The portion of the organic layer having the second thickness may include a lower region and an upper region, wherein the width of the upper region may be smaller than the width of the lower region.

The height of the lower region may correspond to the height of the microcavity.

According to an exemplary embodiment of the present system and method, the above-described display device and manufacturing method thereof have the following benefits.

The display device according to an exemplary embodiment of the present system and method has reduced weight, thickness, cost, and processing time because the display device is manufactured using one substrate.

Furthermore, the manufacturing process of the display device is simplified according to an exemplary embodiment of the present system and method because a roof layer is formed by forming an organic layer and then bending it.

### BRIEF DESCRIPTION OF THE DRAWINGS

FIG. 1 is a top plan view showing a display device according to an exemplary embodiment of the present system and method.

FIG. 2 is an equivalent circuit diagram of a pixel of a display device according to an exemplary embodiment of the present system and method.

FIG. 3 is a layout view showing a part of a display device according to an exemplary embodiment of the present system and method.

FIG. 4 is a cross-sectional view of the display device of FIG. 3 taken along line IV-IV according to an exemplary embodiment of the present system and method.

FIG. 5 is a cross-sectional view of the display device of FIG. 3 taken along line V-V according to an exemplary embodiment of the present system and method.

FIGS. 6, 7, 8, 9, 10 and 11 are cross-sectional process diagrams showing a manufacturing method of a display device according to an exemplary embodiment of the present system and method.

FIG. 12 is a cross-sectional view of a display device according to an exemplary embodiment of the present system and method.

FIG. 13 is a cross-sectional process diagram showing some steps of a manufacturing method of a display device according to an exemplary embodiment of the present system and method.

### DETAILED DESCRIPTION OF THE EMBODIMENTS

The present system and method are described more fully hereinafter with reference to the accompanying drawings in which exemplary embodiments of the system and method are shown. Those of ordinary skill in the art would realize that the described embodiments may be modified in various different ways without departing from the spirit or scope of the present system and method.

In the drawings, the thickness of layers, films, panels, regions, etc., are exaggerated for clarity. Like reference numerals designate like elements throughout the specification. When an element such as a layer, film, region, or substrate is referred to as being “on” another element, it may be directly on the other element, or intervening elements may also be present. In contrast, when an element is referred to as being “directly on” another element, there are no intervening elements present.

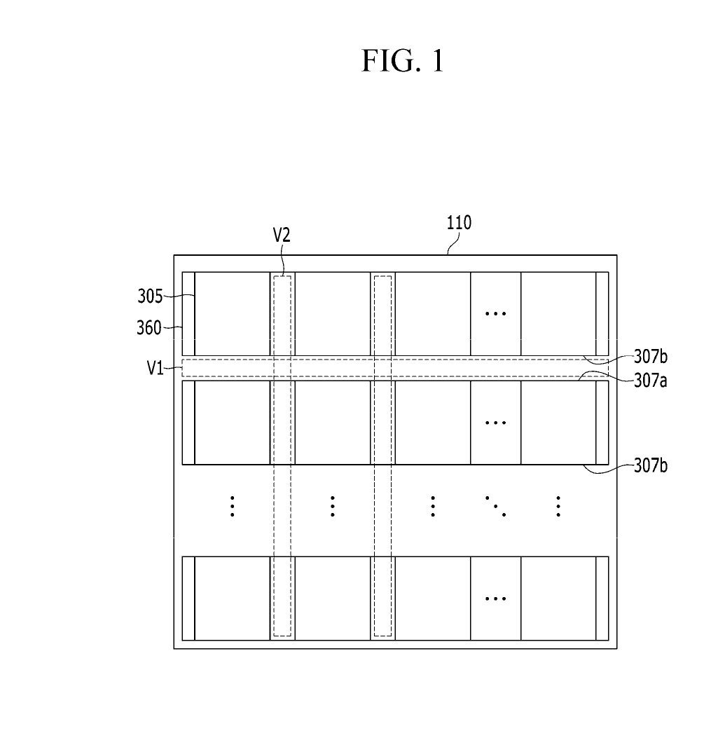

First, a display device according to an exemplary embodiment of the present system and method is schematically described below with reference to FIG. 1.

FIG. 1 is a top plan view showing a display device according to an exemplary embodiment of the present system and method.

The display device includes a substrate 110 made of a material such as glass or plastic.

A plurality of microcavities 305 each covered with a roof layer 360 are formed on the substrate 110. The plurality of roof layers 360 are formed on the substrate 110. Roof layers 360 adjacent to each other in a row are in contact with each other, and roof layers 360 adjacent to each other in a column are separated from each other. One microcavity 305 is formed under one roof layer 360.

The microcavities 305 may be disposed in a matrix. First valleys V1 are disposed between each pair of microcavities 305 adjacent in a column, and second valleys V2 are disposed between each pair of microcavities 305 adjacent in a row.

The first valleys V1 are disposed between each pair of roof layers 360 adjacent in a column. Each microcavity 305 may be externally exposed by openings along its edges facing the first valleys V1, rather than being covered with the roof layer 360. These openings are referred to as injection holes 307a and 307b.

The injection holes 307a and 307b are formed on two opposite edges of a microcavity 305. The injection holes 307a and 307b include a first injection hole 307a and a second injection hole 307b. The first injection hole 307a is formed to expose the side surface of a first edge of the microcavity 305, and the second injection hole 307b is formed to expose the side surface of a second edge of the microcavity 305. The side surface of the first edge of the microcavity 305 faces the side surface of the second edge of an adjacent microcavity 305 a column.

Each roof layer 360 is formed in such a way that it is spaced apart from the substrate 110 between adjacent second valleys V2, thereby forming a microcavity 305. That is, each roof layer 360 is formed to cover the other side surfaces of the microcavity 305, except the side surfaces of the first and second edges where the injection holes 307a and 307b are formed.

The above-described structure of a display device according to an exemplary embodiment of the present system and method is only an illustration, and may be modified in various ways. For example, the layout of the microcavities 305, first valleys V1, and second valleys V2 may be modified, a plurality of roof layers 360 may be connected together at the first valleys V1, and part of each roof layer 360 may be spaced apart from the substrate 110 at the second valleys V2 so that adjacent microcavities 305 are connected together.

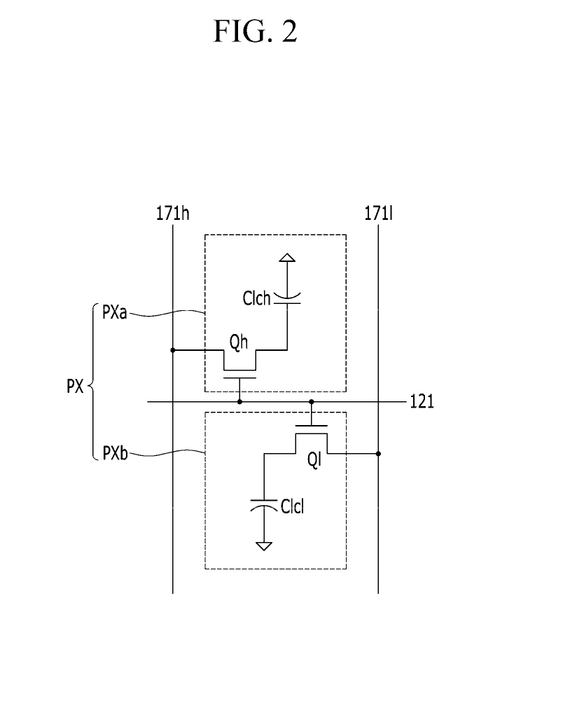

Hereinafter, a pixel of a display device according to an exemplary embodiment of the present system and method is schematically described with reference to FIG. 2.

FIG. 2 is an equivalent circuit diagram of a pixel of a display device according to an exemplary embodiment of the present system and method. The display device includes a plurality of signal lines 121, 171h, and 171l and a pixel PX connected to them. Although not shown, a plurality of pixels PX may be disposed in a matrix including a plurality of pixel rows and a plurality of pixel columns.

Each pixel PX may include a first subpixel PXa and a second subpixel PXb. The first subpixel PXa and the second subpixel PXb may be disposed adjacent to each other in a pixel column. In this instance, a first valley V1 may be disposed along a pixel row between the first subpixel PXa and the second subpixel PXb, and a second valley V2 may be disposed between each of the pixel columns.

The signal lines 121, 171h, and 171l include a gate line 121 for transmitting a gate signal, and a first data line 171h and a second data line 171l for transmitting different data voltages.

A first thin film transistor Qh is formed to be connected to the gate line 121 and the first data line 171h, and a second thin film transistor Ql is formed to be connected to the gate line 121 and the second data line 171l.

A first liquid crystal capacitor Clch connected to the first thin film transistor Qh is formed in the first subpixel PXa, and a second thin film transistor Clcl connected to the second thin film transistor Ql is formed in the second subpixel PXb.

A first terminal of the first thin film transistor Qh is connected to the gate line 121, a second terminal thereof is connected to the first data line 171h, and a third terminal thereof is connected to the first liquid crystal capacitor Clch.

A first terminal of the second thin film transistor Ql is connected to the gate line 121, a second terminal thereof is connected to the second data line 171l, and a third terminal thereof is connected to the second liquid crystal capacitor Clcl.

As for the operation of the display device of FIG. 2, when a gate-on voltage is applied to the gate line 121, the first thin film transistor Qh and second thin film transistor Ql connected to the gate line 121 are turned on, and the first and second liquid crystal capacitors Clch and Clcl are charged with different data voltages transmitted through the first and second data lines 171h and 171l. The data voltage transmitted through the second data line 171l is lower than the data voltage transmitted through the first data line 171h. Accordingly, the second liquid crystal capacitor Clcl is charged with a lower voltage than the first liquid crystal capacitor Clch, thereby improving side visibility.

However, the present system and method are not limited to the above describe configuration, and the layout design of thin film transistors for applying different voltages to the two subpixels PXa and PXb may be modified in various ways. Also, a pixel PX may include two or more subpixels, or may consist of a single pixel.

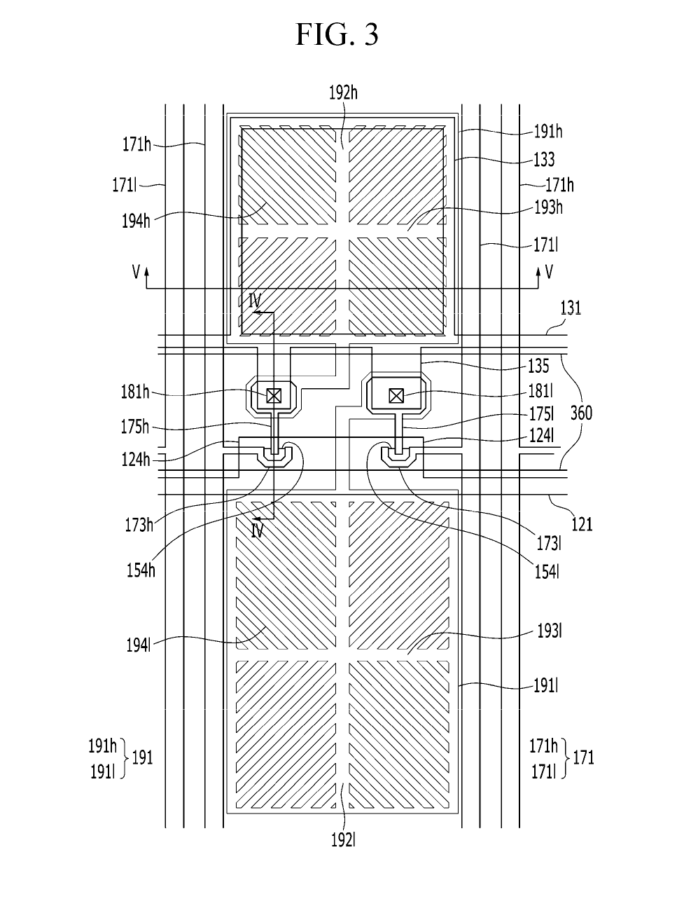

Hereinafter, a structure of one pixel of a display device according to an exemplary embodiment of the present system and method is described with reference to FIGS. 3 to 5.

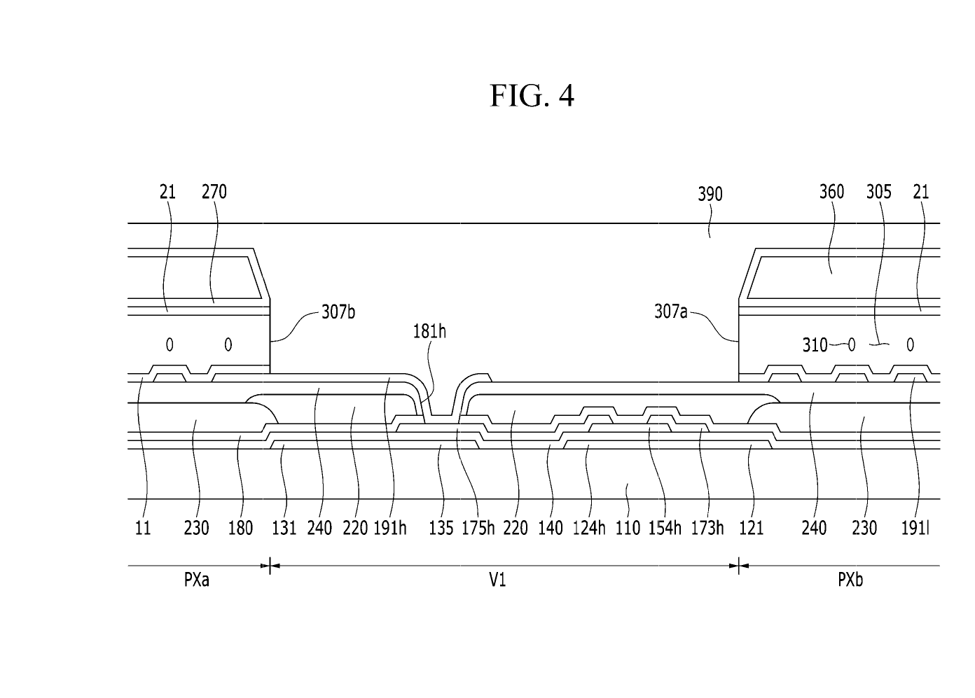

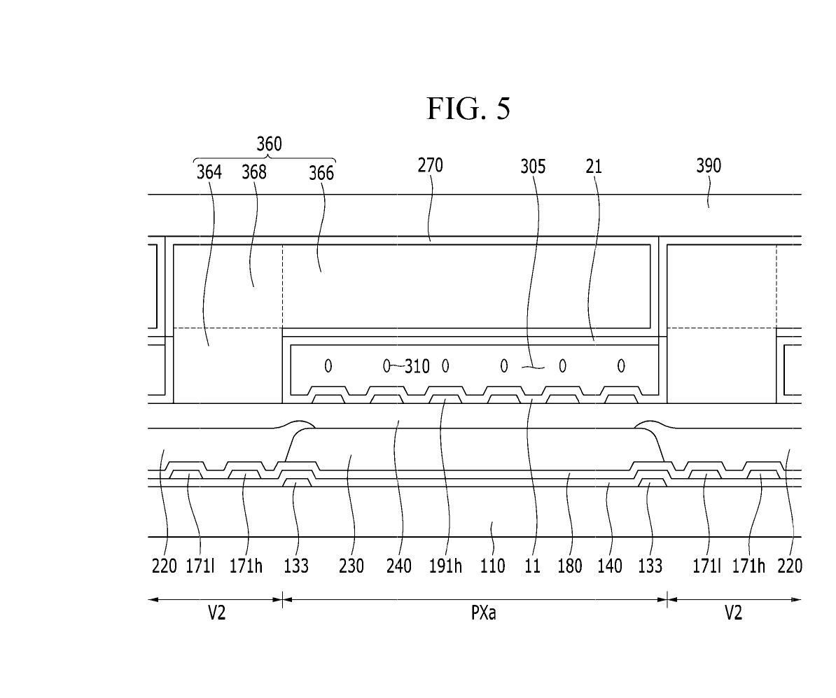

FIG. 3 is a layout view showing a part of a display device according to an exemplary embodiment of the present system and method. FIG. 4 is a cross-sectional view of the display device of FIG. 3 taken along line IV-IV according to an exemplary embodiment of the present system and method. FIG. 5 is a cross-sectional view of the display device of FIG. 3 taken along line V-V according to an exemplary embodiment of the present system and method.

Referring to FIGS. 3 to 5, a gate line 121 and first and second gate electrodes 124h and 124l protruding from the gate line 121 are formed on a substrate 110.

The gate line 121 extends in a first direction and transmits a gate signal. The gate line 121 is disposed between two microcavities 305 adjacent to each other in a column. That is, the gate line 121 is disposed in a first valley V1. The first gate electrode 124h and the second gate electrode 124l protrude upward (orientation as shown in FIG. 3) from the gate line 121 on a top plan view. The first gate electrode 124h and the second gate electrode 124l may be connected together to form one protruding portion. However, the present system and method are not limited to the above described configuration, and the first gate electrode 124h and the second gate electrode 124l may protrude in various shapes.

A storage electrode line 131 and storage electrodes 133 and 135 protruding from the storage electrode line 131 may be further formed on the substrate 110. The storage electrode line 131 extends in a direction parallel to the gate line 121, and is spaced apart from the gate line 121. A constant voltage may be applied to the storage electrode line 131. The storage electrode 133 protruding upward (orientation as shown in FIG. 3) from the storage electrode line 131 is formed to surround the edges of the first subpixel PXa. The storage electrode 135 protruding downward (orientation as shown in FIG. 3) from the storage electrode line 131 is formed adjacent to the first gate electrode 124h and the second gate electrode 124l.

A gate insulating layer 140 is formed on the gate line 121, the first gate electrode 124h, the second gate electrode 124l, the storage electrode line 131, and the storage electrodes 133 and 135. The gate insulating layer 140 may be made of an inorganic insulating material such as a silicon nitride (SiNx) or a silicon oxide (SiOx). Also, the gate insulating layer 140 may be made up of a single layer or multiple layers.

A first semiconductor 154h and a second semiconductor 154l are formed on the gate insulating layer 140. The first semiconductor 154h may be disposed above (orientation as shown in FIG. 4) the first gate electrode 124h, and the second semiconductor 154l may be disposed above the second gate electrode 124l. The first semiconductor 154h may also be formed under (orientation as shown in FIG. 4) a first source electrode 173h, and the second semiconductor 154l may also be formed under a second source electrode 173l. The first semiconductor 154h and the second semiconductor 154l may be made of amorphous silicon, polycrystalline silicon, a metal oxide, and so on.

An ohmic contact member (not shown) may be further formed on each of the first and second semiconductors 154h and 154l. The ohmic contact member may be made of a material such as a silicide or n+ hydrogenated amorphous silicon doped with an n-type impurity at a high concentration.

The first data line 171h, the second data line 171l, the first source electrode 173h, a first drain electrode 175h, the second source electrode 173l, and a second drain electrode 175l are formed on the first semiconductor 154h, the second semiconductor 154l, and the gate insulating layer 140.

The first data line 171h and the second data line 171l transmit a data signal, extend in a second direction, and intersect the gate line 121 and the storage electrode line 131. The data lines 171 are disposed between two microcavities 305 adjacent to each other in a row. That is, the data lines 171 are disposed in a second valley V2.

The first data line 171h and the second data line 171l transmit different data voltages. For example, the data voltage transmitted through the second data line 171l is lower than the data voltage transmitted through the first data line 171h.

The first source electrode 173h is formed so as to protrude from the first data line 171h to overlap the first gate electrode 124h, and the second source electrode 173l is formed so as to protrude from the second data line 171l to overlap the second gate electrode 124l. The first drain electrode 175h and the second drain electrode 175l each include one wide end portion and a bar-shaped end portion. The wide end portions of the first drain electrode 175h and second drain electrode 175l overlap the storage electrode 135 protruding downward from the storage electrode line 131. The bar-shaped end portions of the first drain electrode 175h and second drain electrode 175l are partially surrounded by the first source electrode 173h and the second source electrode 173l, respectively.

The first and second gate electrodes 124h and 124l, the first and second source electrodes 173h and 173l, and the first and second drain electrodes 175h and 175l, along with the first and second semiconductors 154h and 154l, constitute first and second thin film transistors (TFTs) Qh and Ql, respectively. In this instance, channels of the thin film transistors are formed in the semiconductors 154h and 154l between the source electrodes 173h and 173l and the drain electrodes 175h and 175l, respectively.

A passivation layer 180 is formed on the first data line 171h, the second data line 171l, the first source electrode 173h, the first drain electrode 175h, the first semiconductor layer 154h exposed between the first source electrode 173h and the first drain electrode 175h, the second source electrode 173l, the second drain electrode 175l, and the second semiconductor layer 154l exposed between the second source electrode 173l and the second drain electrode 175l. The passivation layer 180 may be made of an organic insulating material or an inorganic insulating material, and may be made of a single layer or multiple layers.

Color filters 230 may be formed in each pixel PX on the passivation layer 180.

Each color filter 230 may display a primary color such as red, green, and blue. The color filters 230, however, are not limited to displaying the three primary colors, such as red, green, and blue, and may also display cyan, magenta, yellow, white-based colors, and the like. The color filters 230 may not be formed in the first valley V1 and/or the second valley V2.

A light blocking member 220 is formed in an area between neighboring color filters 230. The light blocking member 220 may be formed on the boundary and thin film transistors Qh and Ql of the pixel PX, thereby preventing light leakage. That is, the light blocking member 220 may be formed in the first valley V1 and the second valley V2. The color filters 230 and the light blocking member 220 may overlap each other in some areas.

A first insulating layer 240 may be further formed on the color filters 230 and the light blocking member 220. The first insulating layer 240 may be made of an organic insulating material, and may serve to planarize the top surfaces of the color filters 230 and of the light blocking member 220. The first insulating layer 240 may be multilayered and include a layer made of an organic insulating material and a layer made of an inorganic insulating material. The first insulating layer 240 may be omitted in some cases.

A first contact hole 181h exposing the wide end portion of the first drain electrode 175h and a second contact hole 181l exposing the wide end portion of the second drain electrode 175l are formed in the passivation layer 180 and the first insulating layer 240.

A pixel electrode 191 is formed on the first insulating layer 240. The pixel electrode 191 may be made of a transparent metal oxide such as indium tin oxide (ITO), indium zinc oxide (IZO), etc.

The pixel electrode 191 includes a first subpixel electrode 191h and a second subpixel electrode 191l that are separated from each other with the gate line 121 and the storage electrode line 131 interposed between them. The first subpixel electrode 191h and the second subpixel electrode 191l are disposed in upper and lower (orientation as shown in FIG. 3) parts of the pixel PX with respect to the gate line 121 and the storage electrode line 131. That is, the first subpixel electrode 191h and the second subpixel electrode 191l are separated from each other with the first valley V1 interposed between them, the first subpixel electrode 191h is disposed in the first subpixel PXa, and the second subpixel electrode 191l is disposed in the second subpixel PXb.

The first subpixel electrode 191h is connected to the first drain electrode 175h via the first contact hole 181h, and the second subpixel electrode 191l is connected to the second drain electrode 175l via the second contact hole 181l. Accordingly, when the first thin film transistor Qh and the second thin film transistor Ql are in the on state, the first subpixel electrode 191h and the second subpixel electrode 191l receive different data voltages from the first drain electrode 175h and the second drain electrode 175l, respectively.

The overall shape of the first subpixel electrode 191h and the second subpixel electrode 191l is rectangular. The first subpixel electrode 191h and the second subpixel electrode 191l each include cross-like stem portions, such as a horizontal stem portion ( 193h and 191l, respectively) and a vertical stem portion ( 192h and 192l, respectively) crossing the horizontal stem portion. Further, the first subpixel electrode 191h and the second subpixel electrode 191l each include a plurality of minute branch portions 194h and 194l, respectively.

Each of the subpixel electrodes 191h and 191l is divided into four subregions by the horizontal stem portions 193h and 193l and the vertical stem portions 192h and 192l, respectively. The minute branch portions 194h and 194l obliquely extend from the horizontal stem portions 193h and 193l and the vertical stem portions 192h and 192l, respectively, in a direction that may form an angle of approximately 45 degrees or 135 degrees with the gate line 121 or with the horizontal stem portions 193h and 193l. Further, the directions in which the minute branch portions 194h and 194l of two neighboring subregions extend may be perpendicular to each other.

In the present exemplary embodiment of FIG. 3, the first subpixel electrode 191h and the second subpixel electrode 191l may further include outer stem portions surrounding the outer edges of the first subpixel PXa and second subpixel PXb, respectively.

The layout of the pixel, the structure of the thin film transistors, and the shape of the pixel electrodes described above are only examples, and the present system and method are not limited thereto and may be modified in various ways.

A roof layer 360 is formed on the pixel electrode 191 in such a manner so as to be spaced apart from the pixel electrode 191 by a certain distance. A microcavity 305 is disposed between the pixel electrode 191 and the roof layer 360. That is, the microcavity 305 is encapsulated by the pixel electrode 191 and the roof layer 360 except along the sides of the microcavity 305 where the injection holes 307a and 307b are formed. A plurality of microcavities 305 and a plurality of roof layers 360 are formed, and one microcavity 305 is formed under one roof layer 360. That is, according to an exemplary embodiment, the number of roof layers 360 is equal to the number of microcavities 305.

The roof layers 360 have a bent bar shape, i.e., an L shape, as the cross-sectional view of FIG. 5 shows. Each roof layer 360 includes a column portion 364 covering one side surface of the microcavity 305, a ceiling portion 366 covering the top surface of the microcavity 305, and a connecting portion 368 connecting the column portion 364 and the ceiling portion 366. The column portion 364 and the connecting portion 368 are disposed in a second valley V2 between adjacent pixel electrodes 191. The ceiling portion 366 is disposed in a pixel area PX and overlaps the pixel electrode 191.

The ceiling portion 366 of one of two adjacent roof layers 360 is in contact with the connecting portion 368 of the other roof layer 360. One microcavity 305 is surrounded by two roof layers 360. As for the microcavity 305 disposed at the center of FIG. 5, the left side surface and top surface of the microcavity 305 are covered with one roof layer 360, and the right side surface of the microcavity 305 is covered with an adjacent roof layer 360. In other words, one side surface and the top surface of the microcavity 305 are covered with one of two adjacent roof layers 360, and the other side surface of the microcavity 305 is covered with the other roof layer 360.

The roof layer 360 may be made of an organic material, which may become firm by a hardening process, and serve to maintain the shape of the microcavity 305.

The roof layers 360 are formed in such a way so as to not cover some parts of the side surfaces of the edges of the microcavity 305. The parts of the microcavity 305 not covered with the roof layer 360 are referred to as injection holes 307a and 307b. The injection holes 307a and 307b include a first injection hole 307a exposing the side surface of a first edge of the microcavity 305 and a second injection hole 307b exposing the side surface of a second edge of the microcavity 305. The first edge and the second edge face each other. For example, in a top plan view (see FIG. 1), the first edge may be the upper edge of the microcavity 305, and the second edge may be the lower edge of the microcavity 305. Since the microcavity 305 is exposed by the injection holes 307a and 307b in the manufacturing process of a display device, an aligning agent or a liquid crystal material may be injected into the microcavity 305 via the injection holes 307a and 307b.

A portion of a common electrode 270 is disposed between two adjacent roof layers 360. The two adjacent roof layers 360 are separated from each other with the common electrode 270 interposed between them. A portion of the common electrode 270 disposed on either one of the two adjacent roof layers 360 is connected to another portion of the common electrode 270 disposed on the other roof layer 360. The common electrode 270 is disposed on the top surface, bottom surface, and side surface of the ceiling portion 366 of the roof layer 360, and on the top surface and side surface of the connecting portion 368 of the roof layer 360. The microcavity 305 is disposed below the common electrode 270 (orientation as shown in FIG. 5).

However, the present system and method are not limited to the above configuration, and the common electrode 270 may be formed with an insulating layer interposed between it and the pixel electrode 191. Either the common electrode 270 or the pixel electrode 191 may have a planar shape, and the other may have a bar shape. Also, the common electrode 270 and the pixel electrode 191 may be formed on the same layer, and a bar-shaped common electrode 270 and a bar-shaped pixel electrode 191 may be alternately arranged. In this instance, the microcavity 305 may be disposed on the common electrode 270.

The common electrode 270 may be made of a transparent metal oxide such as indium tin oxide (ITO), indium zinc oxide (IZO), etc. A constant voltage may be applied to the common electrode 270, and an electric field may be formed between the pixel electrode 191 and the common electrode 270.

Alignment layers 11 and 21 are formed on the pixel electrode 191 and under the common electrode 270, respectively.

The alignment layers 11 and 21 include a first alignment layer 11 and a second alignment layer 21. The first alignment layer 11 and the second alignment layer 21 may be vertical alignment layers or horizontal alignment layers, and may be made of an alignment material such as a polyimide. The first and second alignment layers 11 and 21 may be connected to each other at the sidewalls of the edges of the microcavity 305.

The first alignment layer 11 is formed on the pixel electrode 191. The first alignment layer 11 may be formed directly on the first insulating layer 240 that is not covered with the pixel electrode 191.

The second alignment layer 21 is formed under the common electrode 270 so as to face the first alignment layer 11.

A liquid crystal layer made up of liquid crystal molecules 310 is formed within the microcavity 305 disposed between the pixel electrode 191 and the roof layer 360. The liquid crystal molecules 310 have negative dielectric anisotropy or positive dielectric anisotropy.

When data voltages are applied to the first subpixel electrode 191h and second subpixel electrode 191l, and a constant voltage is applied to the common electrode 270, an electric field that determines the alignment direction of the liquid crystal molecules 310 disposed within the microcavity 305 between the two electrodes 191 and 270 is generated. As such, the luminance of light passing through the liquid crystal layer varies according to the determined alignment direction of the liquid crystal molecules 310.

An encapsulation layer 390 is formed on the common electrode 270. The encapsulation layer 390 is formed to cover the injection holes 307a and 307b that externally expose some parts of the microcavity 305. That is, the encapsulation layer 390 may seal the microcavity 305 so as to keep the liquid crystal molecules 310 within the microcavity 305 from coming out. Since the encapsulation layer 390 is in contact with the liquid crystal molecules 310, the encapsulation layer 390 may be made of a material that does not react with the liquid crystal molecules 310. For example, the encapsulation layer 390 may be made of parylene.

The encapsulation layer 390 may have a multilayer structure such as a double-layer structure or a triple-layer structure. The double-layer structure is made up of two layers made of different materials. The triple-layer structure is made up of three layers in which adjacent layers are made of different materials. For example, the encapsulation layer 390 may include a layer made of an organic insulating material and a layer made of an inorganic insulating material.

Although not shown, polarizers may be further formed on the upper and lower surfaces of the display device. The polarizers may include a first polarizer and a second polarizer. The first polarizer may be attached onto the lower surface of the substrate 110, and the second polarizer may be attached onto the encapsulation layer 390.

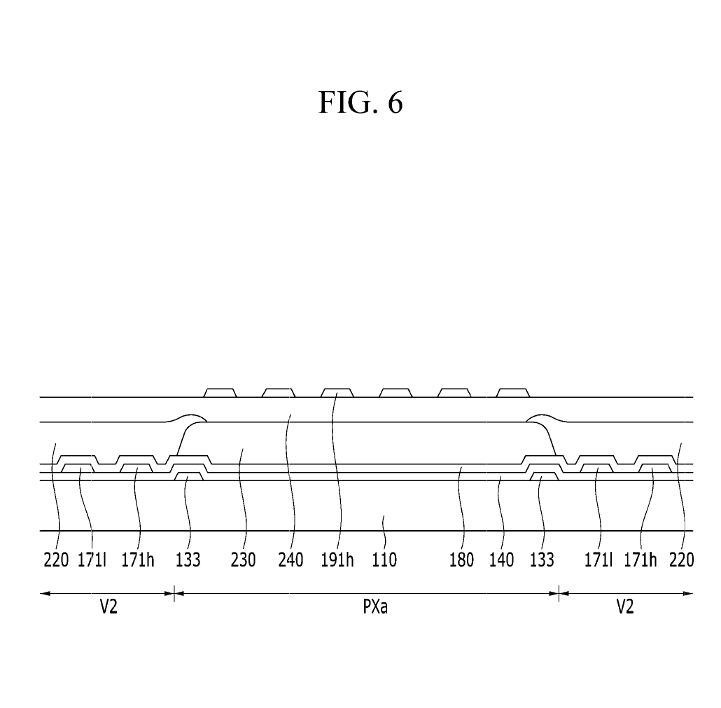

Hereinafter, a manufacturing method of a display device according to an exemplary embodiment of the present system and method is described with reference to FIGS. 6 to 11. Also, the description is given with reference to FIGS. 1 to FIG. 5 again.

FIGS. 6 to FIG. 11 are cross-sectional process diagrams showing a manufacturing method of a display device according to an exemplary embodiment of the present system and method.

First of all, as shown in FIG. 6, a gate line 121 extending in a first direction and first and second gate electrodes 124h and 124l protruding from the gate line 121 are formed on a substrate 110 made of glass, plastic, etc. The first gate electrode 124h and the second gate electrode 124l may be connected together to form one protruding portion.

Moreover, a storage electrode line 131 and storage electrodes 133 and 135 protruding from the storage electrode line 131 may be formed together and may be spaced apart from the gate line 121. The storage electrode line 131 extends in a direction parallel to the gate line 121. The storage electrode 133 protruding upward (orientation as shown in FIG. 3) from the storage electrode line 131 may be formed to surround the edges of a first subpixel PXa. The storage electrode 135 protruding downward (orientation as shown in FIG. 3) from the storage electrode line 131 may be formed to be adjacent to the first gate electrode 124h and the second gate electrode 124l.

Subsequently, a gate insulating layer 140 is formed on the gate line 121, the first gate electrode 124h, the second gate electrode 124l, the storage electrode line 131, and the storage electrodes 133 and 135 by using an inorganic insulating material such as a silicon nitride (SiNx), a silicon oxide (SiOx), etc. The gate insulating layer 140 may be made up of a single layer or multiple layers.

Subsequently, a first semiconductor 154h and a second semiconductor 154l are formed by depositing a semiconductor material such as amorphous silicon, polycrystalline silicon, a metal oxide, etc., on the gate insulating layer 140 and then patterning it. The first semiconductor 154h may be disposed above (orientation as shown in FIG. 4) the first gate electrode 124h, and the second semiconductor 154l may be disposed above the second gate electrode 124l.

Subsequently, a first data line 171h and a second data line 171l that extend in a second direction are formed by depositing a metal material and then patterning it. The metal material may be made up of a single layer or multiple layers.

Moreover, a first source electrode 173h protruding from the first data line 171h and overlapping the first gate electrode 124h and a first drain electrode 175h spaced apart from the first source electrode 173h are formed together. In addition, a second source electrode 173l protruding from the second data line 171l and overlapping the second gate electrode 124l and a second drain electrode 175l spaced apart from the second source electrode 173l are formed together.

The first and second semiconductors 154h and 154l, the first and second data lines 171h and 171l, the first and second source electrodes 173h and 173l, and the first and second drain electrodes 175h and 175l may be formed by sequentially depositing a semiconductor material and a metal material and simultaneously patterning them. In this instance, the first semiconductor 154h may also be formed under (orientation as shown in FIG. 4) the first source electrode 173h, and the second semiconductor 154l may also be formed under the second source electrode 173l.

The first and second gate electrodes 124h and 124l, the first and second source electrodes 173h and 173l, and the first and second drain electrodes 175h and 175l, along with the first and second semiconductors 154h and 154l, constitute first and second thin film transistors (TFTs) Qh and Ql, respectively.

Subsequently, a passivation layer 180 is formed on the first data line 171h, the second data line 171l, the first source electrode 173h, the first drain electrode 175h, the first semiconductor layer 154h exposed between the first source electrode 173h and the first drain electrode 175h, the second source electrode 173l, the second drain electrode 175l, and the second semiconductor layer 154l exposed between the second source electrode 173l and the second drain electrode 175l. The passivation layer 180 may be made of an organic insulating material or an inorganic insulating material, and may be made up of a single layer or multiple layers.

Subsequently, color filters 230 are formed on the passivation layer 180. The color filters 230 may be formed in the first subpixel PXa and a second subpixel PXb, and may not be formed in the first valleys V1. Color filters 230 of the same color may be formed along a column of a plurality of pixel areas PX. In the formation of color filters 230 of three colors, the color filter 230 of a first color may be formed first, the color filter 230 of a second color may be then formed by shifting a mask, and the color filter 230 of a third color may be then formed by shifting the mask again.

Next, a light blocking member 220 is formed on the boundary and switching elements of each pixel PX on the passivation layer 180 by using a light blocking material.

The light blocking member 220 is disposed in a first valley V1 and a second valley V2. The thin film transistors Qh and Ql are disposed in the first valley V1, and the light blocking member 220 overlaps the thin film transistors Qh and Ql. Moreover, the light blocking member 220 may overlap the gate line 121, the storage electrode line 131, and the data lines 171.

Subsequently, a first insulating layer 240 is formed on the color filters 230 and the light blocking member 220.

A first contact hole 181h exposing at least a part of the first drain electrode 175h and a second contact hole 181l exposing at least a part of the second drain electrode 175 are formed by patterning the passivation layer 180 and the first insulating layer 240.

A pixel electrode 191 is formed in the pixel area PX by depositing a transparent metal material, such as indium tin oxide (ITO), indium zinc oxide (IZO), etc., on the first insulating layer 240 and then patterning it. The pixel electrode 191 includes a first subpixel electrode 191h disposed in the first subpixel PXa and a second subpixel electrode 191l disposed in the second subpixel PXb. The first subpixel electrode 191h and the second subpixel electrode 191h may be disposed in such a way so as to be separated from each other with the first valley V1 interposed between them.

Horizontal stem portions 193h and 193l and vertical stem portions 192h and 192l crossing the horizontal stem portions 193h and 193l are formed at the first subpixel electrode 191h and the second subpixel electrode 191l, respectively. Moreover, a plurality of minute branch portions 194h and 194l that obliquely extend from the horizontal stem portions 193h and 193l and the vertical stem portions 192h and 192l, respectively, are formed.

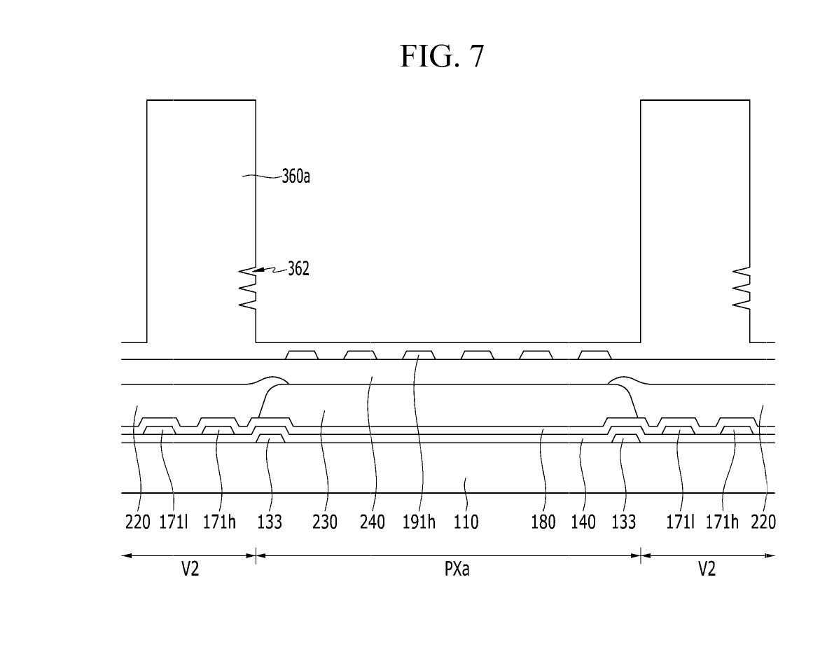

As shown in FIG. 7, an organic layer 360a is formed by applying an organic material on the pixel electrode 191 and the first insulating layer 240.

The organic layer 360a has a first thickness at a portion overlapping the pixel electrode 191 and a second thickness at a portion (hereinafter, a “thick portion”) not overlapping the pixel electrode 191, and the second thickness is greater than the first thickness. The organic layer 360a has the second thickness in the second valleys V2. The organic layer 360a is not formed in the first valleys V1.

At least one groove 362 is formed on a side surface of a thick portion of the organic layer 360a. The number of grooves 362 formed in each thick portion of the organic layer 360a may be an odd number. For example, one, three, five, etc., grooves may be formed in each thick portion of the organic layer 360a.

The grooves 362 are formed on only one side surface of each thick portion of the organic layer 360a, such as shown in FIG. 7. For example, the grooves 362 may be formed on the right side surface (orientation as shown in FIG. 7) of each thick portion of the organic layer 360a but not on the left side surface of thereof. Cross-sections of the grooves 362 may have a V-shape.

There are various ways of forming an organic layer 360a with grooves 362. For example, an organic layer 360a with grooves 362 on only one side surface may be formed by using a technology such as stereolithography, micro laser sintering, micro 3D printing, etc.

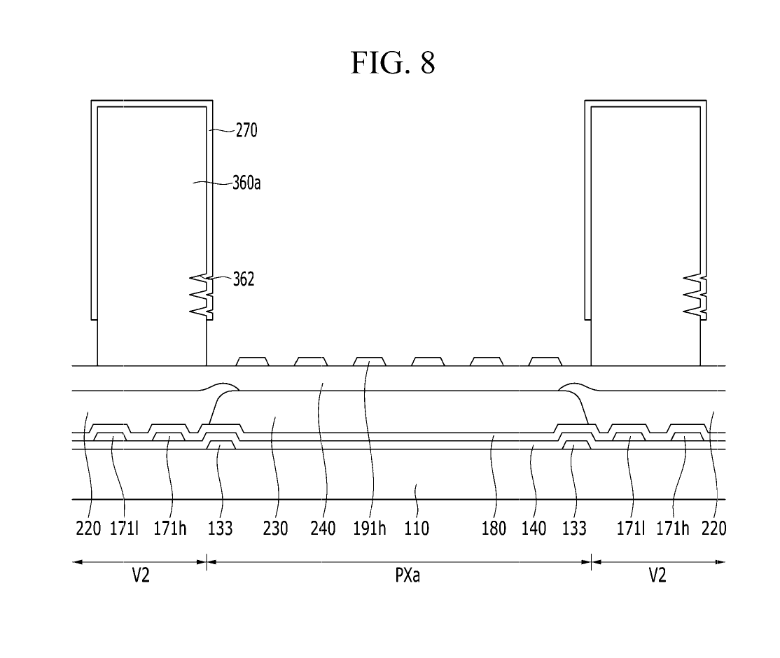

As shown in FIG. 8, a common electrode 270 is formed by depositing a transparent metal oxide, such as indium tin oxide (ITO), indium zinc oxide (IZO), etc., on the organic layer 360a and then patterning it. The common electrode 270 is formed only on the thick portion of the organic layer 360a having the second thickness.

Subsequently, the portion of the organic layer 360a having the first thickness is removed.

Although the foregoing describes an example in which the common electrode 270 is formed on the organic layer 360a, the present system and method are not limited to this example. The common electrode 270 may be formed prior to the formation of the organic layer 360a. That is, the common electrode 270 may be disposed under the organic layer 360a.

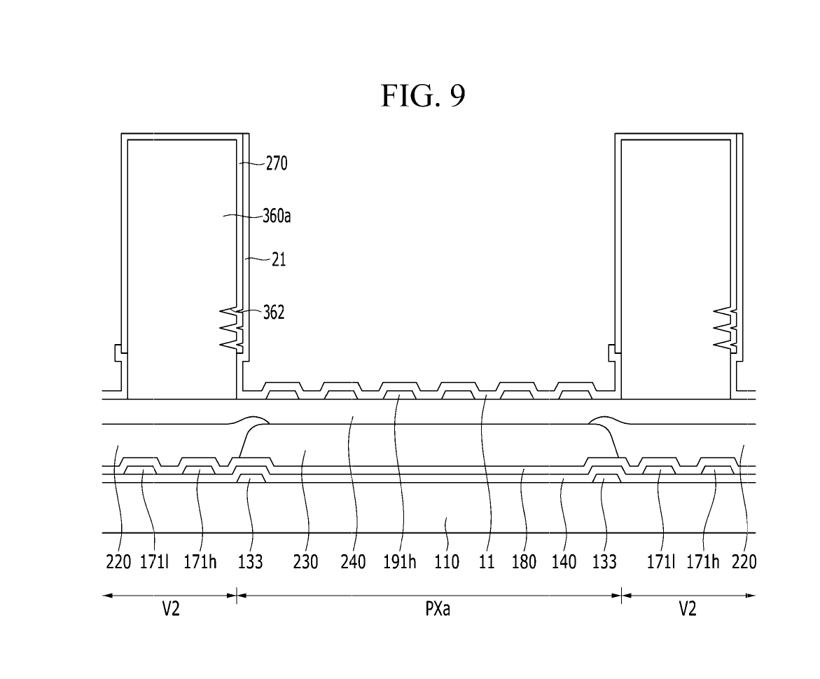

As shown in FIG. 9, alignment layers 11 and 21 are formed on the pixel electrode 191 and the organic layer 360a, respectively. The alignment layers 11 and 21 may include a polyimide as a main constituent. Polyimides tend to contract at high temperatures.

The alignment layers 11 and 21 include a first alignment layer 11 and a second alignment layer 21. The first alignment layer 11 is disposed on the pixel electrode 191. The second alignment layer 21 is disposed on the side surface of the organic layer 360a, but not on the top surface of the organic layer 360a.

The alignment layers 11 and 21 may be disposed within the grooves 362. Thus, the alignment layers 11 and 21 have more polyimide in the region where the grooves 362 are formed than in the surrounding regions.

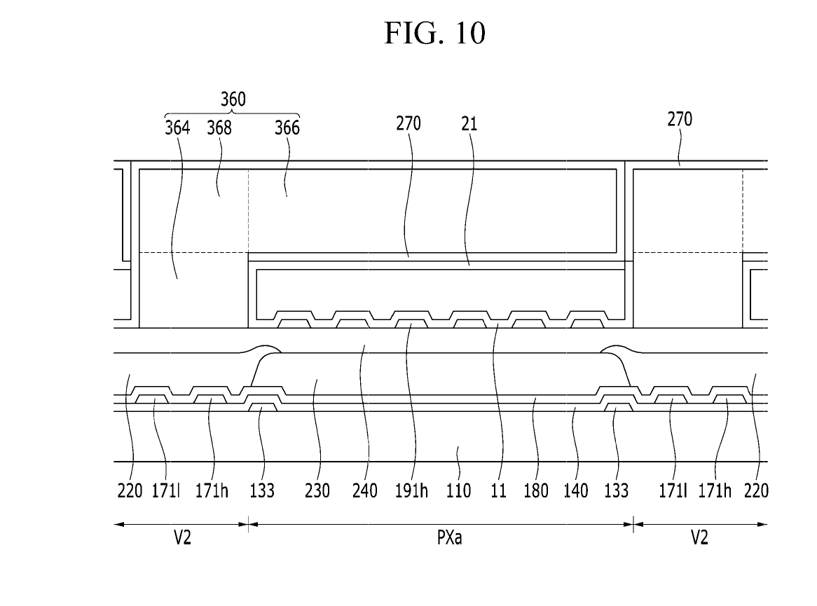

As shown in FIG. 10, the alignment layers 11 and 21 are dried by performing a heat treatment process on the substrate 110. The heat treatment process may be performed at a temperature between 200 and 250 degrees Celsius. Due to the heat treatment process, the alignment layers 11 and 21 contract, and the organic layer 360a standing at right angles to the substrate 110 becomes tilted. In this instance, the region where the grooves 362 are formed is bent.

That is, during the heat treatment process, the thick portion of the organic layer 360a bends toward the side where the grooves 362 are disposed to become an L-shaped roof layer 360, which is formed in such a manner so as to be spaced apart from the pixel electrode 191 with a microcavity 305 interposed between them. The microcavity 305 is disposed between the pixel electrode 191 and the roof layer 360. That is, the microcavity 305 is surrounded by the pixel electrode 191 and the roof layer 360. A plurality of microcavities 305 and a plurality of roof layers 360 are formed, and one microcavity 305 is formed under one roof layer 360. That is, the number of roof layers 360 is equal to the number of microcavities 305.

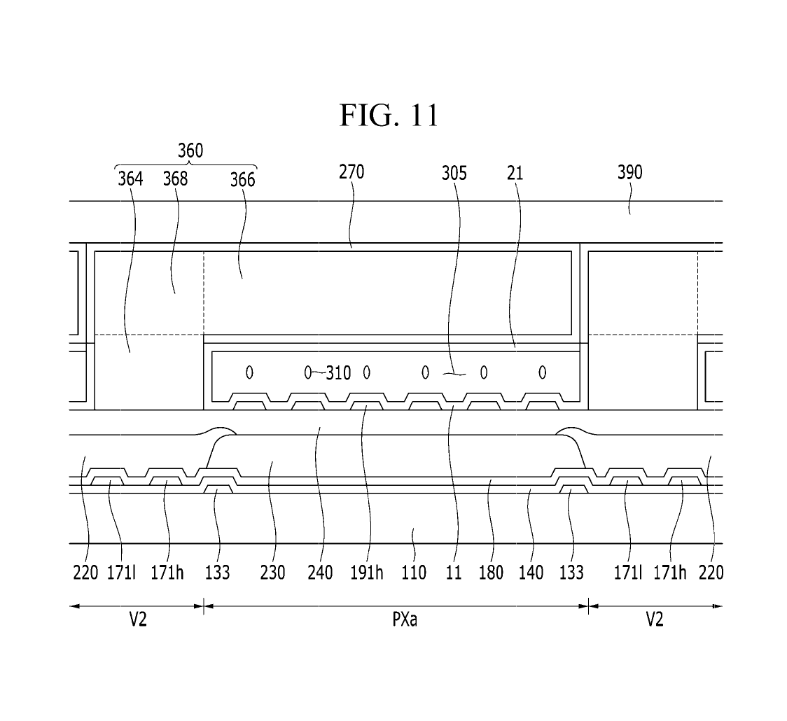

The roof layers 360 have a bent bar shape, i.e., an L shape, as the cross-sectional view of FIG. 11 shows. Each roof layer 360 includes a column portion 364 covering one side surface of the microcavity 305, a ceiling portion 366 covering the top surface of the microcavity 305, and a connecting portion 368 connecting the column portion 364 and the ceiling portion 366. The column portion 364 and the connecting portion 368 are disposed in a second valley V2 between adjacent pixel electrodes 191. The ceiling portion 366 is disposed in a pixel area PX and overlaps the pixel electrode 191.

As the organic layer 360a standing at right angles to the substrate 110 is bent, the portion of the common electrode 270 on the top surface of the organic layer 360a is brought into contact with the common electrode 270 on a side surface of an adjacent organic layer 360a. The ceiling portion 366 of one of two adjacent roof layers 360 is separated from the connecting portion 368 of the other roof layer 360 by the common electrode 270. One microcavity 305 is surrounded by two roof layers 360. As for the microcavity 305 disposed at the center of FIG. 11, the left side surface and top surface of the microcavity 305 are covered with one roof layer 360, and the right side surface of the microcavity 305 is covered with an adjacent roof layer 360. In other words, one side surface and the top surface of a microcavity 305 are covered with either one of two adjacent roof layers 360, and the other side surface of the microcavity 305 is covered with the other roof layer 360.

The roof layers 360 are formed in such a way so as to not cover some parts of the side surfaces of the edges of the microcavity 305. The parts of the microcavity 305 not covered with the roof layer 360 are referred to as injection holes 307a and 307b.

Subsequently, when a liquid crystal material is dripped on the substrate 110 by an inkjet method or a dispending method, the liquid crystal material is injected into the microcavity 305 via the injection holes 307a and 307b by capillary force. Accordingly, a liquid crystal layer made up of liquid crystal molecules 310 is formed within the microcavity 305.

Subsequently, an encapsulation layer 390 is formed on the common electrode 270 by using a material that does not react with the liquid crystal molecules 320. The encapsulation layer 390 is formed to cover the injection holes 307a and 307b, and seals the microcavity 305 so as to keep the liquid crystal molecules 310 formed within the microcavity 305 from coming out.

Subsequently, although not shown, polarizers may be further attached onto the upper and lower surfaces of the display device. The polarizers may include a first polarizer and a second polarizer. The first polarizer may be attached onto the lower surface of the substrate 110, and the second polarizer may be attached onto the encapsulation layer 390.

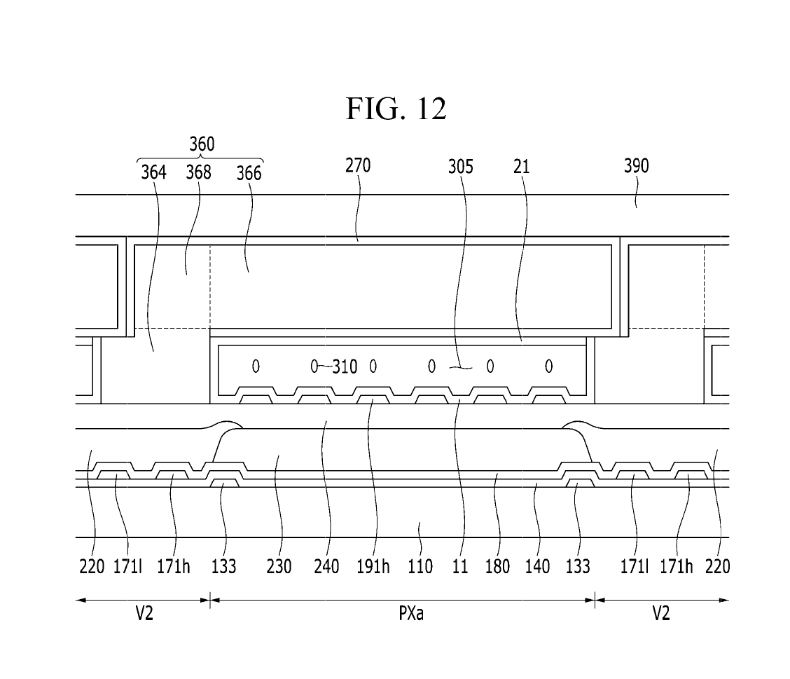

Next, a display device according to an exemplary embodiment of the present system and method is described below with reference to FIG. 12.

Since the display device illustrated in FIG. 12 is substantially identical to the display device illustrated in FIGS. 1 to 5, overlapping description thereof is omitted. The shape of the roof layers in the exemplary embodiment of FIG. 12 differs from that of the foregoing exemplary embodiment. The differences are described in more detail below.

FIG. 12 is a cross-sectional view of a display device according to an exemplary embodiment of the present system and method.

As stated in the foregoing exemplary embodiment, microcavities 305 each covered with a roof layer 360 are formed on a substrate 110. The roof layer 360 has an L shape, and includes a column portion 364 covering one side surface of the microcavity 305, a ceiling portion 366 covering the top surface of the microcavity 305, and a connecting portion 368 connecting the column portion 364 and the ceiling portion 366.

In the foregoing exemplary embodiment, the width of the column portion 364 of the roof layer 360 is substantially equal to the width of the connecting portion 368 of the roof layer 360, and the width of the connecting portion 368 of the column portion 364 of the roof layer 360 is substantially equal to the thickness of the ceiling portion 366. In the present exemplary embodiment of FIG. 12, the width of the connecting portion 368 of the roof layer 360 is smaller than the width of the column portion 364, and the width of the connecting portion 368 of the roof layer 360 is substantially equal to the thickness of the ceiling portion 366. The width of the column portion 364 of the roof layer 360 is larger than the thickness of the ceiling portion 366.

Accordingly, the column portion 364 and connecting portion 368 of the roof layer 360 are stepped. Two adjacent roof layers 360 are separated from each other with the common electrode 270 disposed in between. Particularly, the ceiling portion 366 of one of two adjacent roof layers 360 is separated from the connecting portion 368 of the other roof layer 360 by the common electrode 270. In this instance, an edge of the ceiling portion 366 of either one of the two roof layers 360 is disposed on the column portion 364 of the other roof layer 360. That is, the column portion 364 of a roof layer 360 supports the ceiling portion of an adjacent roof layer 360.

In the manufacturing process of such a display device, the shape of the roof layers may be determined by controlling the shape of the organic layer.

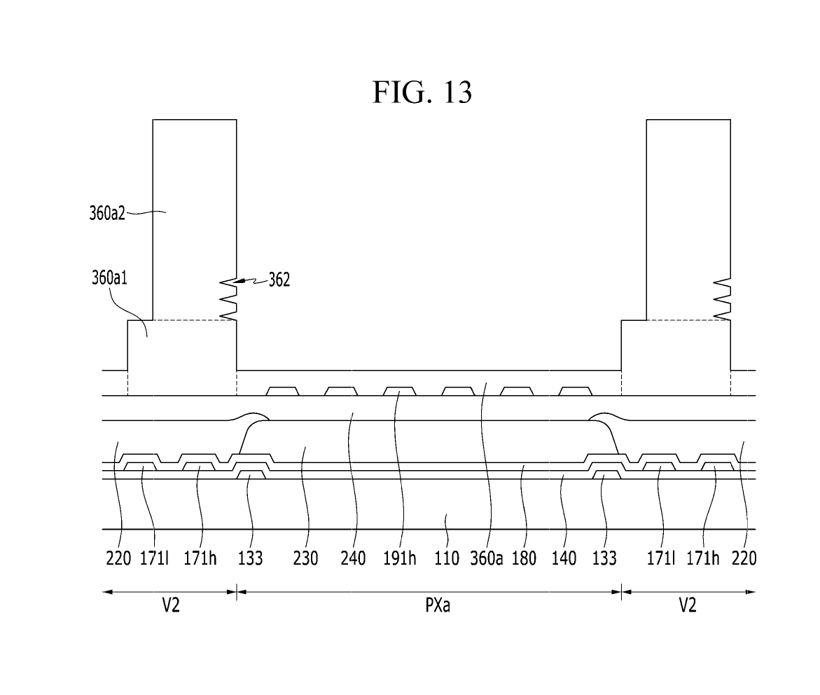

Hereinafter, the shape of an organic layer that is formed in the manufacturing process of a display device according to an exemplary embodiment of the present system and method is described with reference to FIG. 13.

FIG. 13 is a cross-sectional process diagram showing some steps of a manufacturing method of a display device according to an exemplary embodiment of the present system and method. FIG. 13 illustrates the step of forming an organic layer by applying an organic material on a pixel electrode and a first insulating layer.

The organic layer 360a has a first thickness at a portion overlapping the pixel electrode 191 and a second thickness at a portion not overlapping the pixel electrode 191 (the “thick portion”), and the second thickness is greater than the first thickness. The organic layer 360a has the second thickness in the second valleys V2. The organic layer 360a is not formed in the first valleys V1. At least one groove 362 is formed on a side surface of each thick portion of the organic layer 360a. Grooves 362 are formed on only one side surface of each thick portion of the organic layer 360a, and cross-sections of the grooves 362 may have a V-shape.

The thick portion of the organic layer 360a includes a lower region 360a1 and an upper region 360a2. The width of the upper region 360a2 is smaller than the width of the lower region 360a1. Accordingly, a side surface of the organic layer 360a is stepped. The stepped side surface of the organic layer 360a is disposed opposite to the side surface where grooves 362 are formed. That is, one side surface of each thick portion of the organic layer 360a has grooves 362, and the other side surface is stepped.

The height of the lower region 360a1 corresponds to the height of a microcavity 305. That is, the height of the lower region 360a1 is substantially equal to the height of the microcavity 305.

In the subsequent steps, a roof layer is formed by bending the organic layer 360a such that the lower region 360a1 of the organic layer 360a supports the upper region 360a2 of an adjacent organic layer 360a. Accordingly, the height of the microcavity 305 can be kept constant.

While the present system and method are described above in connection with exemplary embodiments, the present system and method are not limited to the disclosed embodiments, but, on the contrary, is intended to cover various modifications and equivalent arrangements included within the spirit and scope of the appended claims.

<Description of symbols>

| | |
|---|---|
| 110: substrate | 121: gate line |
| 131: storage electrode line | 171: data line |
| 180: passivation layer | 191: pixel electrode |
| 220: light blocking member | 230: color filter |
| 305: microcavity | 310: liquid crystal molecule |
| 360: roof layer | 362: groove |
| 364: column portion of roof layer | 366: ceiling portion of roof layer |
| 368: connecting portion of roof layer | 360a: organic layer |
| 360a1: lower region of organic layer | |
| 360a2: upper region of organic layer | |
| 390: encapsulation layer | |

What is claimed is:

1. A display device comprising:
a substrate;
a thin film transistor disposed on the substrate;
a pixel electrode connected to the thin film transistor;
a roof layer formed above the pixel electrode to be spaced apart from the pixel electrode with a microcavity therebetween;
a liquid crystal layer disposed in the microcavity; and
an encapsulation layer disposed on the roof layer and sealing the microcavity,
wherein the roof layer has an L-shape.

2. The display device of claim 1, further comprising a plurality of microcavities and a plurality of roof layers.

3. The display device of claim 2, wherein the number of roof layers is equal to the number of microcavities.

4. The display device of claim 2, wherein
each roof layer comprises:
a column portion covering one side surface of the microcavity;
a ceiling portion covering the top surface of the microcavity; and
a connecting portion connecting the column portion and the ceiling portion.

5. The display device of claim 4, wherein
the plurality of roof layers comprise a first roof layer and a second roof layer that are adjacent to each other, and
one side surface and the top surface of the microcavity are covered with the first roof layer, and the other side surface of the microcavity is covered with the second roof layer.

6. The display device of claim 5, further comprising a common electrode disposed between the first roof layer and the second roof layer.

7. The display device of claim 6, wherein the first roof layer and the second roof layer are only separated from each other by the common electrode interposed therebetween.

8. The display device of claim 6, wherein the common electrode is disposed on the top surface, bottom surface, and side surface of the ceiling portion of a roof layer and on the top surface and side surface of the connecting portion of the roof layer.

9. The display device of claim 6, wherein
the common electrode comprises a first common electrode disposed on the first roof layer and a second common electrode disposed on the second roof layer, and
the first common electrode and the second common electrode are connected to each other.

10. The display device of claim 4, wherein the width of the connecting portion is smaller than the width of the column portion.

11. A manufacturing method of a display device, the method comprising:
forming a plurality of pixel electrodes on a substrate;
forming an organic layer between the pixel electrodes;
forming an alignment layer on the pixel electrodes and the organic layer;
bending the organic layer to form a roof layer, with a microcavity interposed between the roof layer and the pixel electrode;
forming a liquid crystal layer by injecting a liquid crystal material into the microcavity; and
sealing the microcavity by forming an encapsulation layer to cover exposed parts of the microcavity.

12. The method of claim 11, further comprising forming at least one groove on the side surface of the organic layer.

13. The method of claim 12, wherein the groove has a V-shape.

14. The method of claim 12, wherein the alignment layer is disposed within the groove.

15. The method of claim 12, wherein, in the bending of the organic layer, the organic layer is bent by performing a heat treatment process at a temperature between 200 and 250 degrees Celsius.

16. The method of claim 12, wherein
in the forming of the organic layer, the organic layer is further formed on the pixel electrode,
wherein the organic layer has a first thickness at a portion overlapping the pixel electrode and a second thickness at a portion not overlapping the pixel electrode, and the second thickness is greater than the first thickness.

17. The method of claim 16, further comprising forming a common electrode only on the portion of the organic layer having the second thickness after forming the organic layer.

18. The method of claim 17, further comprising removing the portion of the organic layer having the first thickness.

19. The method of claim 16, wherein
the portion of the organic layer having the second thickness comprises a lower region and an upper region,
wherein the width of the upper region is smaller than the width of the lower region.

20. The method of claim 19, wherein the height of the lower region corresponds to the height of the microcavity.
